(19) United States
(12) Patent Application Publication
(10) Pub. No.: US 2013/0132133 A1
(43) Pub. Date: May 23, 2013

(54) METHODS AND SYSTEMS FOR MOB BOOKING OF HOTEL ROOMS

(71) Applicant: Yann NGONGANG, San Mateo, CA (US)

(72) Inventor: Yann NGONGANG, San Mateo, CA (US)

(73) Assignee: GUESTMOB. INC., San Mateo, CA (US)

(21) Appl. No.: 13/471,090

(22) Filed: May 14, 2012

Related U.S. Application Data
(60) Provisional application No. 61/519,986, filed on Jun. 3, 2011.

(51) Int. Cl. G06Q 10/02; G06Q 50/14

(52) U.S. Cl. CPC G06Q 10/02; G06Q 50/14
USPC 705/5

(57) ABSTRACT

A computer-implemented method for an online travel agent to book hotel rooms over a computer network may comprise generating at least one collection of hotels and presenting the generated at least one collection of hotels to potential guests over the computer network; accepting, over the computer network, bookings from at least some of the potential guests to a selected one of the presented at least one hotel collection; grouping potential guests having booked a selected collection of hotels and sharing at least one common guest characteristic into a mob; conducting a reverse auction with participating ones of the plurality of hotels of the selected collection of hotels for bookings of the mob, and awarding the bookings of the mob to the participating hotel of the selected collection of hotels having won the reverse auction.

### BACKGROUND

This application claims the benefit under 35 U.S.C. §119(e) of Provisional Application Ser. No. 61/519,986, filed Jun. 3, 2011, which application is hereby incorporated herein in its entirety.

Historically, hotels have maintained tight control on their nightly rates, irrespective of the channel through which the rooms were booked. That is, online searches for a given hotel for a given stay are likely to return identical results, irrespective of the online search tool used to carry out the search.

Hotels have been able to maintain such seemingly collaborative and tight price control despite the downward pressure exerted by such online tools as priceline.com, expedia.com and the like. However, it would benefit hotels to have the ability to sell last minute remand hotel inventory at discounted prices, rather than have such inventory stay idle. However, the industry has been reluctant to engage in any public practice that would tend to drive clown room rates any closer to their marginal cost.

### BRIEF DESCRIPTION OF THE DRAWINGS

FIG. 1 is a block diagram of a computer-implemented method for a computer-implemented method for an online travel agent (OTA) to book hotel rooms over a computer network, according to one embodiment.

FIG. 2 is a flowchart of a computer-implemented method for an online travel agent to book hotel rooms over a computer network, according to one embodiment.

FIG. 3 is a flowchart of a computer-implemented method for an online travel agent to make hotel bookings, according to one embodiment.

FIG. 4 shows aspects of a reverse auction, according to one embodiment.

FIG. 5 is a flowchart of a computer-implemented method for a hotel to accept bookings for a plurality of guests, according to one embodiment.

FIG. 6 shows aspects of a computer-implemented method for a hotel to accept bookings for a plurality of guests, according to one embodiment.

FIG. 7 shows further aspects of a computer-implemented method for a hotel to accept bookings for a plurality of guests, according to one embodiment.

FIG. 8 is a block diagram of a computer on which embodiments may be implemented.

### DETAILED DESCRIPTION

One embodiment is a computer-implemented method of enabling a reverse group auction of hotel rooms that is configured to deliver hotel rooms to guests at discounted prices, while enabling hotels to sell remnant hotel inventory at discounted prices that are not officially published in online channels. To do so, a computer-implemented method, according to one embodiment, enables hotels to see pending requests for bookings from a group of pre-paid potential guests and gives the hotels the ability to respond to such requests in a secret auction format by bidding competitively against other hotels in the competitive set until a final price (e.g., room rate) is determined.

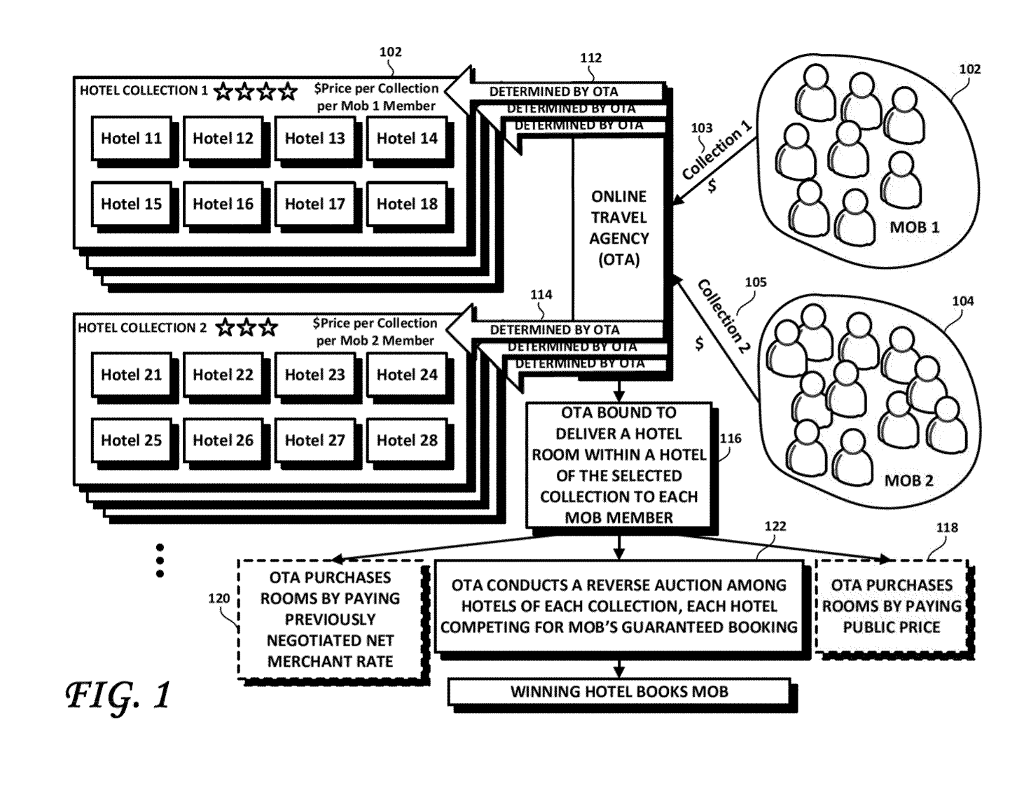

FIG. 1 is a block diagram of a computer-implemented method for a computer-implemented method for an online travel agent to book hotel rooms over a computer network, according to one embodiment. As shown therein, potential guests may be presented with one or more collections of hotels for selection. Indeed, according to one embodiment, one or more hotels may be collected together according to predetermined common hotel characteristics. Two collections of hotels are shown in FIG. 1: Collection of hotels 1 at 108 and Collection of hotels 2 at reference numeral 110. It is to be understood, however, that any number of collections of hotels may be generated. For example, a collection of hotels may comprise a pre-determined number of hotels sharing common or similar characteristic that are listed for opaque (i.e., not publicly broadcast) booking by the OTA 106. The predetermined common hotel characteristics may comprise, for example, location, proximity to a landmark, star rating, amenities, target customer profile, target customer activities and/or any other differentiator or characteristic. The collections of hotels 108, 110 may be defined either manually (e.g., pre-built) based on curation by travel experts, or one or more of the collections of hotels 108, 110 may be assembled algorithmically based on, for example, available hotel data, data mining of customer search histories, or some other algorithm that monitors customers' preferences. The hotels collections may include a combination of human-curated hotels and algorithmically-selected hotels. In FIG. 1, each collection of hotels 108, 110 comprises eight hotels, although a greater or lesser number of hotels may be included in each collection.

In the example of FIG. 1, Collection of Hotels 1, at reference 108, is a collection (e.g., a bundle) of four-star hotels, whereas Collection of Hotels 2, shown at 110, is a collection (e.g., a bundle) of three-star hotels. It is likely that each collection of hotels 108, 110 comprises hotels within a circumscribed geographical area, such that potential guests thereof would experience roughly comparable experiences at each hotel within a given collection (i.e., same star-rating, same general geographical location). According to one embodiment, potential guests do not book a particular hotel. Instead, potential guests book a collection of hotels 108, 110. By booking collection of hotels 108 or 110 according to one embodiment, a potential guest agrees to be assigned, by the OTA 106, to any of the hotels in the collection 108, 110. Potential guests can see each of the hotel properties included in the collection of hotels 108, 110 but cannot, according to one embodiment, specifically request which constituent hotel of a selected collection of hotels 108, 110 to which they will be assigned. Toward that end, the potential guests may be provided with photos and information of the constituent hotels of the collections of hotels 108, 110. For example, a link to the hotel's website may also be provided.

As shown in FIG. 1, Collection of Hotels 1, referenced at 108, comprises eight hotels, referenced at Hotel 11 to Hotel 18 wherein, for ease of reference and illustration, the first digit represents the numeric identifier of the collection of hotels and the second digit represents a numeric identifier of the particular hotel number 1-8 within that collection. Likewise, Collection of Hotels 2, referenced at 110, comprises eight hotels, referenced at Hotel 21 to Hotel 28 wherein, for ease of reference and illustration, the first digit is a numeric identifier of the number of the collection of hotels and the second digit represents the hotel number 1-8 within that collection of hotels.

According to one embodiment, each collection of hotels 108, 110 may be assigned a room rate, which is the price that a mob member (detailed hereunder) must pay for a one night stay for a regular (for example) room at any of the constituent hotels within a given collection. For example, the room rate for rooms at hotels within collection of hotels 108 may be set by the OTA 106 (not the hotels themselves) to $200 and the room rate for rooms at hotels within collection of hotels 110 may be set by the OTA to $150 per room per night. The room rate (e.g., $200 for Collection of Hotels 1 and $150 for Collection of Hotels 2) may be posted May 30, 2012 Page of along with the hotels of each collection of hotels 108, 110, so that the potential guests may choose which of the presented collections of hotels 108, 110 to select.

According to one embodiment, the room rate, set by the OTA 106, may be the same for each member of the mobs 102, 104. According to one embodiment, the room rate within a single collection of hotels 108, 110 may be different for some or for each potential guest. Indeed, the price at which the OTA 106 (not the hotel) will sell a room within a collection of hotels 108, 110 may be algorithmically set for each or some of the potential guests, as suggested at 112 and 114. For example, different potential guests may be assigned different room rates based on their check-in, check-out dates, how far in advance they are booking their hotel stay and may have different social reach (as described hereunder) and/or may be the recipients of different promotional offers and pricing offered by the OTA 106.

As noted above, the price at which the OTA 106 will sell a room within a collection of hotels 108, 110 may be determined algorithmically, by an “instant mob pricing” software module that determines a price at which the OTA 106 will sell a room from the collection of hotels to a potential guest. The room rate for each collection (and for each potential guest, according to one embodiment) may, therefore, be optimized in real time to according to, for example:
a. Public prices of hotels in the collection for the dates requested
b. Pre-negotiated merchant net rates with one or more hotels in the collection
c. GDS (Global Distribution System) commission for public prices
d. Availability/occupancy data from one or more hotels in the collection, or from nearby competitive hotels coming from a proprietary source
e. Availability/occupancy estimated ranges derived from public prices of hotels in the collection and possibly other competitive nearby hotels

Other factors that may affect the pricing of the room rates by the OTA 106 for each collection of hotels may also include, for example, the number of hotels in the collection, the price per night for the dates requested, occupancy data of one or more of the hotels to maximize the expected profit per collection, and an estimate of the outcome of a reverse auction for the mob's bookings (discussed hereunder), and an estimate of the expected gross to net profit from such a reverse auction. Other factors may be taken into account in the determination, by the OTA 106, of the room rate to present to a potential guest viewing a collection of hotels.

According to one embodiment, the generated collections of hotels 108, 110 may be presented (at the OTA's online website, for example) to potential guests. As noted above, the potential guests may each see the same room rate or some or all of the potential guests may see different room rates for the same collection of hotels 108, 110. The potential guests may then review the collections of hotels 108, 110 online and may each select a desired collection of hotels 108, 110, thereby indicating their willingness to stay at any of the collections hotels at the room rate indicated for the selected hotel collection. According to one embodiment, along with their selection of a collection of hotels 108, 110, the potential guests also pay or commit to pay at least a portion of the total hotel charges (including at least the room rate shown on the selected collection of hotels times the number of nights of their stay) to the OTA 106, and not to any of the constituent hotels of the selected hotel collection. This may take the form of, for example, a submission of a credit card and an authorization to charge the submitted credit card for a predetermined amount, or some other form of transfer of value from the potential guest to the OTA 106. This selection and payment is shown in FIG. 1 at references 103 and 105. According to one embodiment, alone with their selection of hotel collection, a potential guest may also indicate a preference for a particular hotel within the selected hotel collection. The preference may be configured as an identification of a single hotel, a prioritized list or a complex logical expression of preferred hotels and room rates. For example, potential guest may express preferences and priorities within a selected hotel collection. Thereafter, according to one embodiment, the OTA 106 may assign the guest preferentially to a hotel based on a predetermined preference/price schedule. For instance, while booking a collection of hotels {A, B, C}, a potential guest may create a price preference schedule {(A, 50), (B, 25), (C, 0)} that directs the OTA 106 to pick hotel A, if price of A—$50 is lowest, or pick hotel B is price of B-$25 is lowest, or pick hotel C, if price of C is lowest. Other mechanisms for stating and honoring preferences may be devised, as those of skill may recognize. Alternatively still, the OTA 106 may not provide for the potential guest expressing any preference.

Potential guests sharing at least one common guest characteristic may be virtually grouped together, as shown at 102, 104. Such groups 102, 104, may be colloquially called “mobs”. The potential guests, now pre-paid, may or may not be aware of their status as a mob member. In FIG. 1, Mob 1, referenced at 102, may share one or more common characteristics. Similarly, Mob 2, denoted at reference numeral 104, may share one or more characteristics that, in some way, differ from the common characteristics that unite the members of Mob 1. For example, the potential guests may be virtually grouped into one or more mobs according to common or clustered check-in and/or check-out dates and overlapping or similar hotel requirements, as evidenced by their selection of the same collection of hotels 108, 110. According to one embodiment, such potential (and now pre-paid) guests may be grouped together to create a “mob” of guests whose bookings are subsequently bid on by hotels by bidding against each other at progressively lower and lower bids, thereby leveraging the increased purchasing power of their numbers to encourage the constituent hotels of their selected hotel collection 108, 110 to trade increased volume for a somewhat decreased profit per guest.

For example, Mob 1, referenced at 102 may be comprised of potential guests travelling between Apr. 19-22, 2012 that wish to stay at one of the hotels of collection of hotels 108 during that time period. Likewise and solely for exemplary purposes, Mob 2, referenced at 104 may be comprised of potential guests travelling between July 1, to Jul. 4, 2012 and wish to stay at one of the three-star hotels of collection of hotels 110.

Therefore, at this point, the OTA 106 has accepted a selection of a collection of hotels 108, 110 from potential guests and has secured payment or at least an irrevocable promise to pay from the potential guests, at the room rate associated with the selected collection of hotels 108, 110. Such selection of a collection of hotels 108, 110 by a potential guest and accompanying payment or promise to pay constitutes, according to one embodiment, a booking of a collection of hotels (108 or 110 in the example being developed herein) by the potential guest. Those guests having made a selection of a hotel collection, paid or promised to pay the displayed room rate and that have, for example, the same, similar or otherwise clustered travel dates, may be grouped into a mob, as shown at 102 and 104. As shown in FIG. 1, the members of Mob 1 have selected (and paid for their booking at) Collection of Hotels 1 and the members of Mob 2 have selected (and paid for their booking at) Collection of Hotels 2.

Now that the OTA 106 has accepted a selection of collections of hotels 108, 110 and has accepted payment or a promise to pay from the members of the mobs 102, 104, the OTA 106 is bound to deliver a hotel room to each member of the mobs 102, 104 at a hotel within the collection of hotels 108, 110 selected by each member of the mobs 102, 104, as shown at 116. Indeed, the OTA 106 is now obligated to perform by providing each member of the mobs 102, 104 with a room within the travel dates specified by the mob member at a hotel within the collection of hotels selected by the mob member. At this juncture, the mob members have performed, and the onus is on the OTA to deliver the rooms. According to one embodiment, the OTA 106 may purchase the rooms at a selected one of the constituent hotels within the selected collection of hotels by paying the publicly advertised room rate, as shown at 118. This alternative may, however, yield but a small or negative profit to the OTA 106. Indeed, if the room rate presented to the potential guest in each collection of hotels 108, 110 is lower than the to publicly advertised room rate purchased by the OTA 106, the OTA 106 will lose money on the transactions. Another alternative permitting the OTA 106 to discharge its duty to provide rooms to members of the mobs 102. 104 at a hotel within their selected collection of hotels 108, 110 is for the OTA 106 to purchase the necessary rooms by paying a previously negotiated net merchant rate with one or more hotels within the collections of hotels 108, 110, as shown at 120 in FIG. 1. This alternative may yield a somewhat larger profit to the OTA 106 (depending, for example, on how successfully the OTA 106 negotiated such net merchant rate), provided that the room rate associated with each collection of hotels for each mob member was chosen to be lower than the previously negotiated net merchant rate.

According to one embodiment, the OTA 106 may instead conduct an auction among the constituent hotels of each selected collection of hotels 108, 110, to auction off the pre-paid bookings of the mobs 102, 104. According to one embodiment, the auction conducted by the OTA 106 is a reverse auction, in which each hotel within a collection of hotels bids to compete for the mob's (102, 104) guaranteed bookings, as shown at 122 in FIG. 1. It is to be noted that the OTA 106 acquires the rooms after the potential guest has paid for his or her booking, not before acquiring the customer, as is the case with the conventional OTA or travel agent model. Indeed, the conventional OTA or travel agent model is to either acquire (for consolidators) or contract (for agents) the room and negotiate both the commission and possibly the rate well in advance. Thereafter, based on these parameters, the OTA or travel agent markets the room and eventually picks up customers to fill these previously acquired or contracted rooms. According to one embodiment, the reverse auction may, but need not, start from a predetermined seed price set by the OTA 106. Therefore, according to one embodiment, a first reverse auction may be conducted (by the OTA 106, for example) amongst the hotels of collection of hotels 108 for the bookings of the members of Mob 1, referenced at 102, and a second reverse auction may be conducted (by the OTA 106, for example) amongst the hotels of collection of hotels 110 for the bookings of the members of Mob 2, referenced at 104. A reverse auction may be carried out at any time after the creation of the mob 102, 104; that is, at any time after the potential guests have selected a collection of hotels 108, 110 and paid or committed to pay the room rate set by the OTA 106 and associated with their selected hotel collection. According to one embodiment, a reverse auction may be carried out close to the anticipated travel dates of the members of the mob at which time, presumably, the hotels of the selected collection of hotels may be more willing than they would otherwise be to cut their room rates closer to their respective marginal costs, so that the rooms are not empty during that period of time. In this manner, the hotels may shed their excess room inventory at rates that, while lower than their advertised rates, may be sufficient to enable them to show an operating profit on the excess inventory, which would otherwise remain idle.

The seed price (if one is set) for the reverse auctions, according to one embodiment, may be set by the OTA 106, and not by any of hotels of the selected collections of hotels 108, 110. It is to be noted that it is possible that none of the hotels of a selected collection of hotels 108, 110 chooses to bid in the reverse auction. In that case, the OTA 106 will be relegated to one of the alternatives shown at 118 and 120 to secure the necessary rooms to fulfill its obligations to the members of the mobs 102, 104. The reverse auctions, therefore, may start at an amount dictated by the first bidder or may start at a seed price set by the OTA 106 and end when a final price is reached and a winning participating hotel of the reverse auction is identified, to whom the bookings of the mob 102, 104 may be awarded.

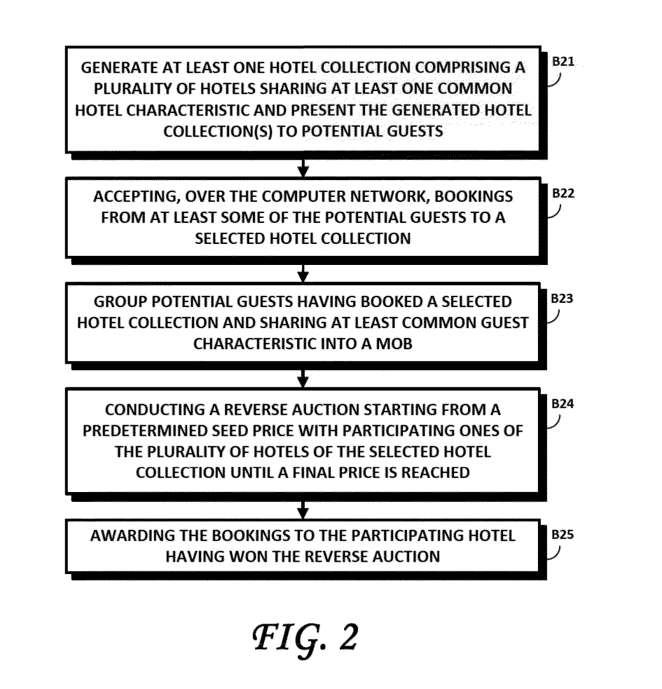

FIG. 2 is a flowchart of a computer-implemented method for an online travel agent to book hotel rooms over a computer network, according to one embodiment. As shown at block B21, one embodiment calls for the generation of one or more hotel collections, each comprising a plurality of hotels sharing at least one common hotel characteristic (such as, for example, location, proximity to a landmark, star rating, amenities, target guest profile and target guest activities), and the presentation of the generated hotel collection(s) to potential guests, over a computer network, for example. It is to be noted that the common characteristic may simply be the fact that the OTA 106 has chosen to include the hotels in a predetermined collection of hotels. Indeed, the hotel collection(s) 108, 110 may be generated by pre-building the hotel collection(s) based on curation by travel professionals and/or algorithmically. According to one embodiment, the algorithmic selection may be based at least in part on guest data such as, for example, guest search histories and monitored guest preferences. A website of (or somehow associated with) the OTA 106 may be used for presenting the generated hotel collection(s) to the potential guests, for example. Returning to FIG. 2, block B22 calls for accepting, over the computer network, bookings from at least some of the potential guests to a selected hotel collection, such as the collections of hotels 108, 110 shown in FIG. 1. Thereafter, block B23 calls for potential guests having booked a selected collection of hotels and sharing at least one common guest characteristic (such as check-in and check-out dates, desired location, desired dates of stay, budget, desired star rating for example) to be grouped into a mob, such as shown at 102 and 104 in FIG. 1. The members of the mob may or may not be aware of their affiliation with or membership in the mob. It is also to be noted that guests may self-form into mobs such as would be the case, for example, when a large family travels together for a special occasion or when a company organizes a group retreat. A reverse auction may be carried out at block B24, starting from a predetermined seed price set by the OTA 106 or from a first received bid by a hotel of the selected collection of hotels. The reverse auction may be carried out with hotels of the selected collection of hotels that choose to participate in the reverse auction until a final price (e.g., a final room rate) is reached. As called for by block B25, the mob's bookings may then be awarded to the participating hotel having won the reverse auction, however such a winning hotel is determined according to the rules of the auction.

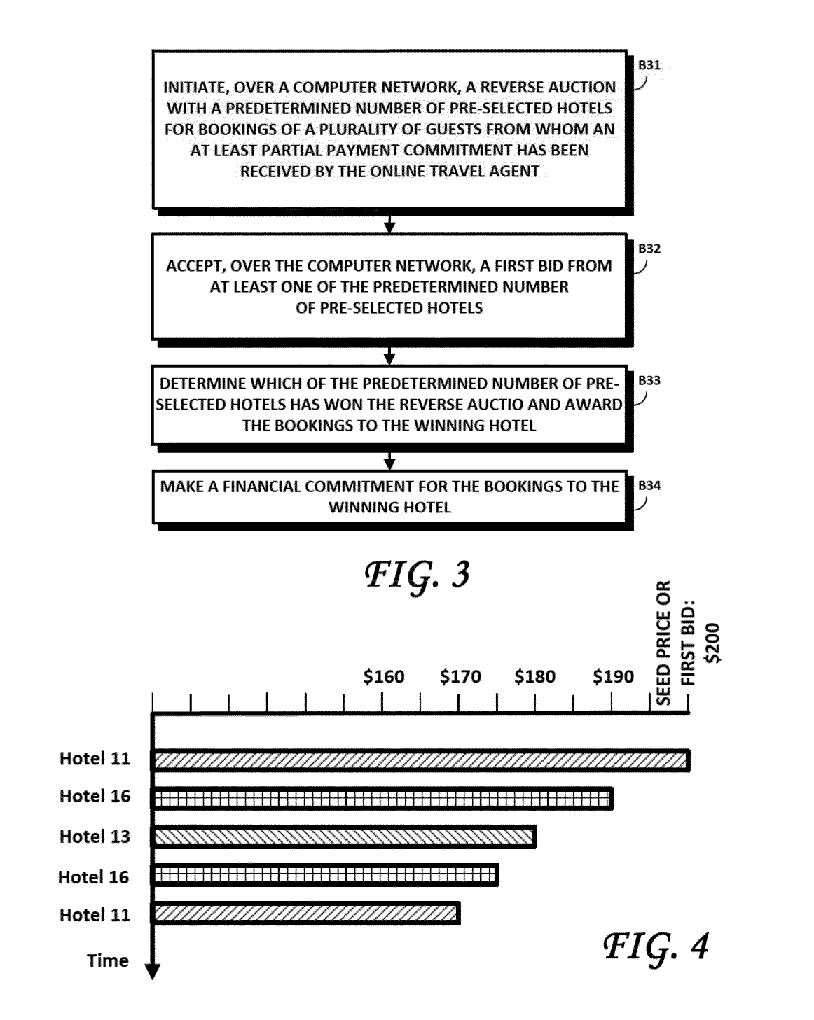

FIG. 3 is a flowchart of computer-implemented method for an online travel agent (such as OTA 106 of FIG. 1) to make hotel bookings, according to one embodiment. Block B31 calls for initiating, over a computer network (comprising the Internet, for example), a reverse auction starting from a first received bid or staring from a predetermined seed price set by the OTA 106 with a predetermined number of pre-selected hotels (also called a collection of hotels herein) for bookings of a plurality of guests from whom an at least partial payment commitment has been received by the OTA 106 (such as, for example, a mob as shown at 102 and 104). Block B32 details accepting, over the computer network, a first bid from at least one of the predetermined number of pre-selected hotels. That is, the entity that conducts the reverse auction (which may be the OTA 106 or a third party on behalf of the OTA 106) may accept a bid (which may be no greater than the predetermined seed price, if a predetermined seed price is set by the OTA 106) from one or more of the hotels of the selected hotel collection. According to one embodiment, the reverse auction may be configured to accept only a single bid from each of the hotels of the selected hotel collection. Alternatively, multiple bids may be accepted from any given hotel within a selected collection, as detailed in greater detail hereunder Thereafter, B33 calls for determining which of the predetermined number of pre-selected hotels has won the reverse auction, according to the rules of the auction, and the bookings being auctioned off may be awarded to the winning hotel. Block B34 then calls for (the OTA 106, for example) to make a financial commitment for the bookings to the hotel having won the reverse auction. Such financial commitment may take the form of a frill or partial payment, immediately upon conclusion of the auction or at some predetermined later time, as negotiated with the winning hotel and/or other involved financial institutions.

The reverse auction may be carried out by the OTA 106 or may be carried out by a third party on behalf of the OTA 106. The OTA 106 may determine the rules of the auction and communicate such rules to the participants. According to one embodiment, conducting the reverse auction comprises accepting a first bid, and thereafter accepting subsequent bids after the first bid. Each such subsequent bid may be lower than, higher than or equal to the accepted first bid. The winner of the reverse auction may be determined as the hotel that placed the lowest bid. However, any type of online auction that causes the constituent hotels of the collection of hotels to compete on price falls within the scope of the present application.

FIG. 4 shows exemplary reverse auction, according to one embodiment. In the example shown in FIG. 4, the seed price (the price at which the reverse auction starts) is $200. This seed price may be set by the OTA 106. According to one embodiment, however, there may be no seed price and the auction can simply start with a first bid from a participating hotel of the selected hotel collection. Before the start of the reverse auction, all of the hotels in the selected collection of hotels (in this case, collection of hotels 1 at 108) may be informed of the auction and its rules and may be invited to submit a bid request via an appropriate communication channel. In the example of FIG. 4, hotels 11, 13 and 16 have responded to the request for bids and have placed bids for the bookings of mob 1, shown in FIG. 1 at 102. As shown therein, hotel 11 (of collection of hotels 1, referenced in FIG. 1 at 108) has placed a bid of $200, which matches the predetermined seed price of $200. In the absence of a predetermined seed price set by the OTA 106, the first bid may be any amount bid by any of the participating hotels of the selected hotel collection. Thereafter, as shown in FIG. 4, hotel 16 (hotel number 6 of Hotel Collection 1) places a bid of $190, this being a reverse auction in which the participating hotels compete for the bookings of the mob at increasingly lower prices. Hotel 13 then places a bid for $180, whereupon hotel 16 counters with an even lower bid of $175. Thereafter, hotel 11 returns with another bid, this time in the amount of $170. Hotel 11's bid ends up being the last and lowest bid. According to one embodiment, the hotel having placed the lowest bid is determined to be the winner of the auction (in this case, Hotel 11) and may be awarded the mob's bookings. The members of the mob for whose bookings the hotels are bidding may then be informed of the identity of the hotel having won the auction. Alternatively, the identity of the bidding hotels may be kept secret, as may be the identity of the winning hotel (except to the winning hotel, of course). According to one embodiment, the members of the mob will stay at the hotel having won the auction at their designated dates. According to one embodiment, the seed price and the final price may be kept secret from the members of the mob for whose bookings the hotels were bidding. The proceedings of the reverse auction may also be kept secret from hotels in other collections and from non-participating hotels in the selected collection of hotels. The final price may also be kept secret from all hotels but the winning hotel. In this example, the OTA 106 is now bound to pay the winning hotel based on the number of guests of the mob for whose bookings the winning hotel was bidding, the length of their stay and a room rate of $170, which is the final price arrived at through the reverse auction process.

According to one embodiment, the winning hotel is that hotel having submitted a lowest bid (Hotel 11 in the example developed with respect to FIG. 4), but the mob's bookings may be awarded to the winning hotel at a winning price corresponding to a received second-lowest bid, minus a pre-determined amount. In the example shown in FIG. 4, Hotel 11 would still be determined to be the winning hotel, but the winning price to be paid to the winning hotel by the OTA 106, is $175 (the second lowest bid, received from hotel 16), minus some pre-determined nominal amount such as, for example, $0.01.

To encourage the development of relationships between the OTA 106 and hotels, selected hotels may benefit from a programmatic (automatically, by a computer-implemented process) selective reduction of their submitted bid, according to predetermined factors. Examples of such predetermined factors may include a perceived quality of the bid-submitting hotel and/or a relationship between the bid-submitting hotel and the OTA 106. For example, the second bid of hotel 16 may have been reduced below that of the subsequently submitted bid of hotel 11, which would have changed the outcome of the reverse auction, as hotel 16 would have been determined to be the winner of the auction.

According to one embodiment, the present mob auction system may comprise a reverse last (or near-last) minute auction where hotels compete against one another in an online system to offer lower and lower bids, until the pre-paid mob presented by the OTA 106 achieves the best price (i.e., room rate) on the hotel booking for members of the mob. Such reverse auctions may be for the bookings of a pre-paid mob of guests, which pre-paid mob may be thought of as a group of guests with clustered booking date requirements and similar hotel requirements. This group of guests can be assigned (at the discretion of the OTA 106) to any hotel within a pre-determined and known set of hotels (i.e., a collection of hotels such as shown at 108, 110) that the guest has reviewed. The phrase “pre-paid” means a group booking where the OTA 106 has obtained a fill or partial payment commitment from the potential guest and is able to make a full financial commitment to any of the hotels of the selected collection of hotels upon booking. According to one embodiment, the auction may be a reverse auction of pre-paid mob bookings, which may comprise an online auction system where hotels are presented with pre-paid bids/requests from a grouping of potential guests with specific check-in and check-out dates, and where hotels participate in the auction by continuously offering lower and lower bids (the average nightly rate per room hotel is willing to accept for the entire mob of guests) until the hotel with the lowest bid wins the auction, at the lowest bid offered by the winning hotel. According to one embodiment, the auction may be a reverse 2nd price auction of pre-paid mob bookings, which comprises an online auction system where hotels are presented with pre-paid bids/requests from potential guests with specific check-in and check-out dates, and hotels participate in the auction by sending a single bid (the absolute minimum nightly rate per room the hotel is willing to accept for the entire mob of guests). The hotel with the lowest bid wins the auction, but the winning price is the 2nd lowest bid, minus a nominal amount, such as $0.01, for example. According to one embodiment, the auction may be a modified 2nd price auction of pre-paid mob bookings, which comprises an online auction system where hotels are presented with pre-paid bids/requests from potential guests with specific check-in and check-out dates, and hotels participate in the auction by sending one bid (the average nightly rate per room the hotel is willing to accept for the entire mob of guests). While ranking the bids of respective hotels, a quality score discount may be applied and may serve as a modifier of the bid by lowering it based on the quality of the hotel, and other negotiated commitments between the hotel and the OTA 106. As such, the hotel winning the auction may be the one with the lowest modified bid, not necessarily the one with the lowest bid. The winning price (i.e., room rate) in such an auction may be the 2nd lowest actual bid (not modified bid), minus a nominal amount such as, for example, $0.01. One embodiment is a reverse auction volume dependent step bid, in which a hotel bid in reverse auction is not a simple number, but rather is a step function representing a set of prices (or discounts off of published room rates) that are indexed to a volume (e.g., number of guests in the mob). For example, a an auction-participating hotel may specify a bid of for example, 10 rooms @30% off Best Available Rate (BAR), 20 rooms @35% off BAR and the like. It will, therefore, be apparent to those of skill in this art that many different kinds of auctions and bidding styles may be implemented to arrive at the final price that the OTA 106 commits to pay to the hotel having won the auction for the bookings of the members of the mob. All such auctions and bidding styles are to be included with the present scope. The present embodiments, therefore, are not to be limited to any one particular type of online auction.

According to one embodiment, the potential guests may log onto or otherwise connect with the OTA 106 through a social network computer site (such as the well-known Facebook®, Twitter® and LinkedIn® sites, for example). Indeed, the OTA 106 may be configured as a socially-aware online travel agent that derives value from its customers' social networks and established personal and professional relationships. By logging on to the OTA 106's website (or other online presence) using their social network credentials, these potential guests can easily recruit other potential guests traveling to the same destination for the same event, recruit potential guests with different travel/lodging needs, or simply become advocates of the OTA 106's value proposition and brand. All such activity may be perceived to have value to the OTA 106 and, according to one embodiment, potential customers may derive some tangible benefit from this perceived value. For example, such tangible benefit may take the form of points that may be redeemed for instant discounts, among other possible benefits. As such, the OTA 106 may include a social discounting module that algorithmically determines the probability that any of the social actions (described above) may occur, the “reach” or social to influence of these actions, and the potential revenue impact to the OTA 106 of such social actions. According to one embodiment, such algorithmic determination may consider and weigh:
The social “reach” of the customer, that is, the number of fans, friends or contacts, the potential guest has on his or her social network(s), or a similar metric;
The social activity of the customer, that is, how often does the potential guest post on his or her social network, the nature of the posts, the number of comments on the potential guest's posts, and how often other people respond, re-tweet, comment on the potential guest's activity on the social network, and/or
Some algorithmic social score of the potential guest, such as a feed with a social influence metric that determines the reach of the potential guest.

According to one embodiment, a social discounting algorithm may be implemented that may return a score that is the basis of points given to the potential guest, and these points may, for example, either be turned into an instant discount applied to the current transaction, or may be used for future promotions with the OTA 106.

According to one embodiment, the room rate for a collection of hotels to a single potential guest may be determined algorithmically by, among other actions, analyzing the social reach and social/reputation score of the potential guest, and determining the probability that the potential guest will broadcast the offer to his or her social network and determining likely impact of such broadcast, likely resulting mob auction size, and gross to net margin.

According to one embodiment, social promotion systems may be implemented in the form of, for example, games based on a potential guest's social network. For example, the OTA 106 may implement a social gaming system called “mob boss” designed to encourage its potential guests to share their travel booking on their social networks. Guests and potential guests may then broadcast the collection of hotels 108, 110 they have selected, along with a broadcast of the average discount they are getting by booking through the OTA 106, with the hope that such broadcasts and the social reach of the potential guest will entice other potential guests to join the mob 102, 104 or any other mob (or even register an account with the OTA 106). The potential guest may then be attributed points based on how many unique visitors click on a given link, registers with the OTA 106, sign up with the potential guest's mob, or sign up with any future mob. According to one embodiment, a social promotion system algorithm may assign points based on the relative importance of each of these actions, with respect to its probability of generating future customers for the OTA 106. Once the mob closes (the point at which no new potential guests are allowed to join the mob, the points may be tallied, and the member of the mob with the highest number of points may be named “mob boss” or some other honorific, and may be offered a variety of prizes, such as, for example, one or more free nights on his/her stay; a free room upgrade, a free limousine ride to and/or from the airport, free breakfast, free valet parking at the hotel, and/or similar perks.

One embodiment includes a mobile auction response platform and notification system for hotel revenue managers. The embodiment comprises a system of auction requests and responses to obtain from hotel sales manager a bid for any mob auction format described above (reverse, reverse 2nd price, reverse modified 2nd price, for example) using, for example, a mobile computing device as input device. Accordingly, the system may comprise a notification component for requests for bids where the hotel manager is informed via automated voice call, video call, sans text message, email message, or a notification message on a mobile device such as an IPhone® (or similar smartphone), IPad® (or similar tablet computer) that a pre-paid mob of potential guests exists with specific check-in and check out dates. The mobile computing device or other input system may then accept a bid from the hotel manager in the form of an average nightly rate per guest for the mob. This submitted bid may then be received and processed automatically by the OTA's servers for example. The submitted bid from the hotel manager may be in form of, for example, a voice response to a request, an sms text response, or by accessing a mobile application on a smartphone or tablet computer. Subsequent bids may be accepted and the winner of the auction determined, as well as the final price (i.e., room rate). The hotel manager may then have an opportunity to confirm the mob's bookings and to receive payment from the OTA 106 at the final price.

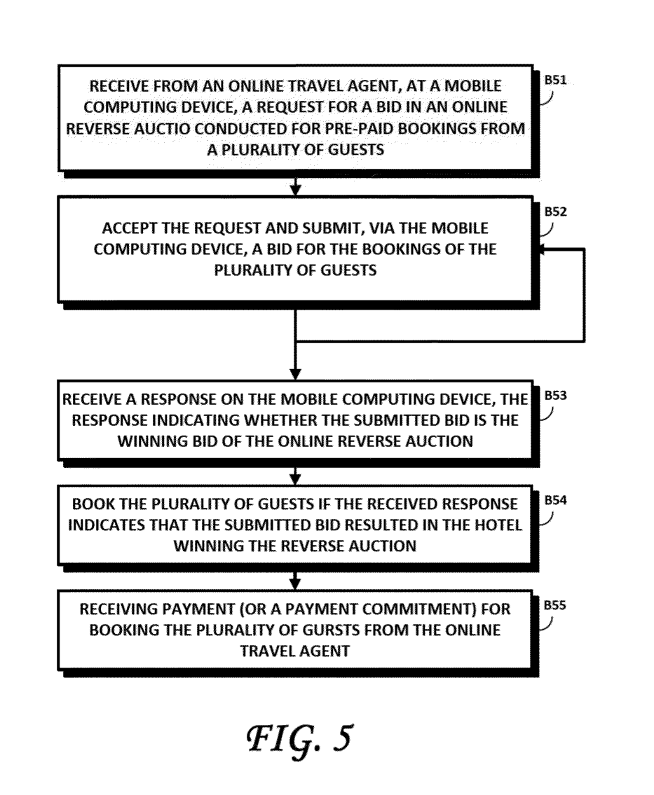

FIG. 5 is a flowchart of a computer-implemented method for a hotel to accept bookings for a plurality of guests. According to one embodiment and as shown at block B51, a hotel manager or other person charged with accepting bookings may receive, from an online travel agent such as OTA 106, a request for a bid in an online reverse auction. The request may be received through most any channel. In the example being developed herewith, the request is received on a mobile computing device. The reverse auction may, as described in detail above, be conducted by an OTA 106 (or by a third party on behalf of the OTA 106) for pre-paid bookings from a plurality of guests, such as a mob 102 or 104. The hotel manager may then accept the request as shown at block B52, and submit a bid via his or her mobile computing device for the bookings of the plurality of guests. Depending upon the rules of the reverse auction, block B52 may be repeated a number of times, to enable the hotel manager to submit more than one bid if he or she has been outbid by other auction participants. The hotel manager may then receive, on his or her mobile computing device, an (optionally anonymous) indication of a last submitted bid by an other participant in the reverse auction for the mob's bookings. Or, the hotel manager may be prompted at B52 to submit his absolute lowest, one-time bid. At block B53, the hotel manager may receive, on his or her mobile computing device or through another channel, a response indicating whether his or her last submitted bid was the winning bid of the reverse auction. As shown at B54, responsive to the received indication that the hotel manager has won the reverse auction, the hotel manager may book the plurality of pre-paid guests of the mob. The winning hotel, as shown at B55, may then receive at least a partial payment or a payment commitment from the OTA 106 for the booking of the plurality of guests. The exact form and timing of the payment may be negotiated between the OTA 106 and/or any involved financial institution.

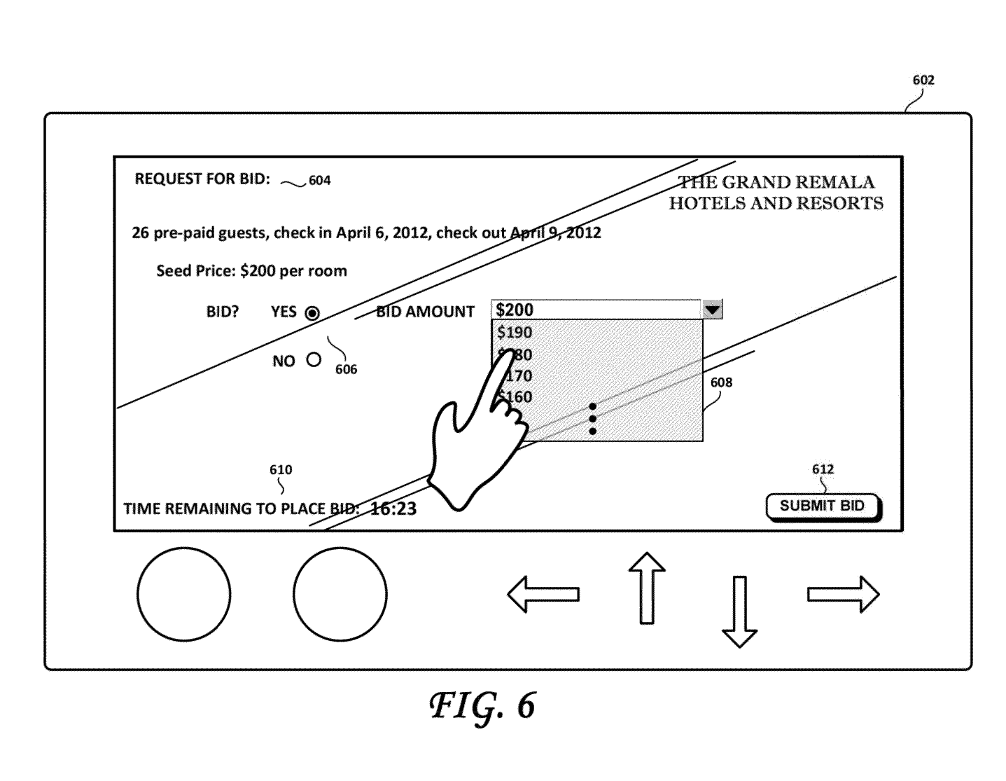

FIG. 6 shows aspects of a computer-implemented method for a hotel to accept bookings for a plurality of guests, according to one embodiment. As shown at 604, the hotel manner may receive a request for a bid in an online reverse auction conducted by or on behalf of the OTA 106 for pre-paid bookings from the plurality of guests. This request may be received on a mobile computing device 602, as shown in FIG. 6. The hotel manager may accept or decline the received request, as suggested by the “YES” and “NO” radio buttons shown at 606. If the hotel manager selects “YES”, he or she may be prompted, via a pull down menu, for example, to select a bid as shown at 608. Possible bids may be pre-populated or a free form user interface tool may be provided to enable the hotel manager to manually enter a desired bid for the bookings of the pre-paid plurality of guests. A timer may be provided indicating the amount of time left in the reverse auction, as shown at 610. The bid may be placed by selecting the “SUBMIT BID” tab, as shown at 612.

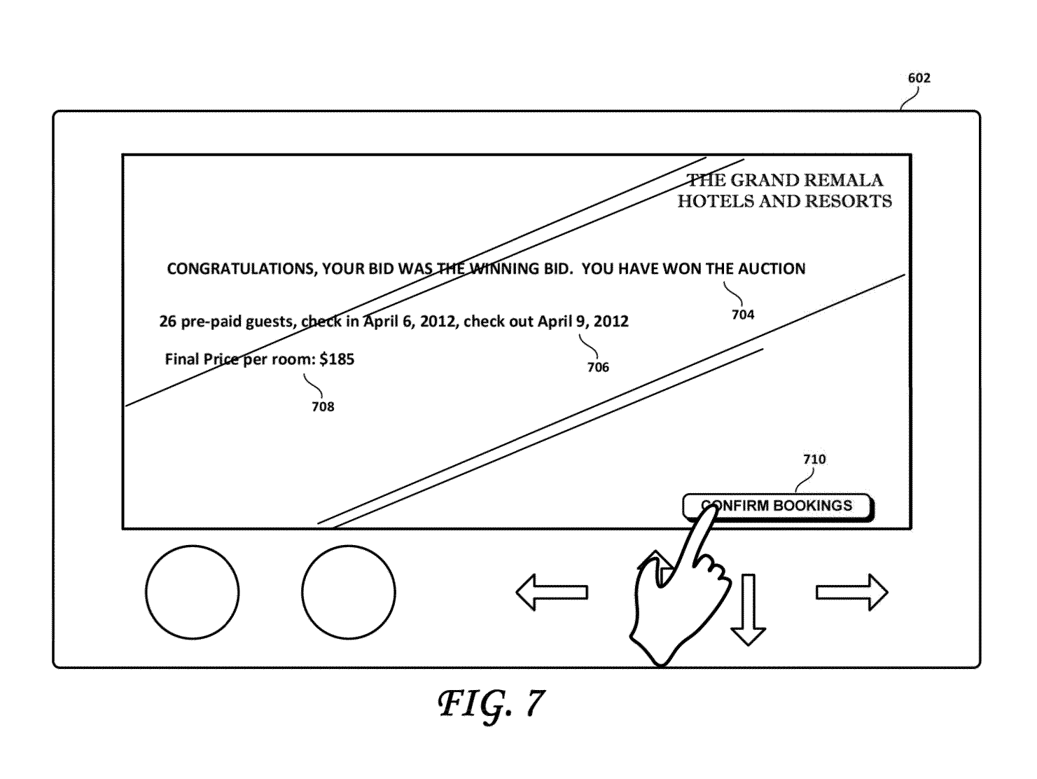

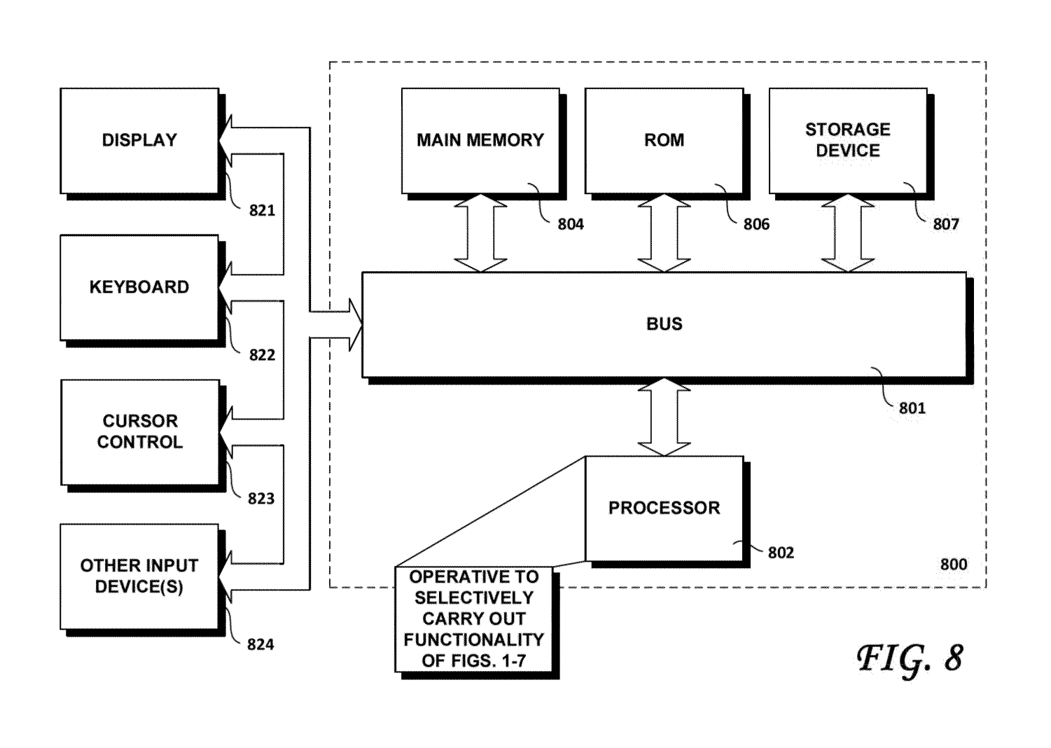

FIG. 7 shows further aspects of a computer-implemented method for a hotel to accept bookings for a plurality of guests, according to one embodiment. As shown at 702, the hotel manager may then receive, on his or her mobile computing device, a response on the mobile computing device 602, the response indicating if the submitted bid is a winning bid of the online reverse auction. The response may also confirm, as shown at 706, the number of guests and their check-in and check-out dates, as well as the final price, as determined by the results of the reverse auction. The final price may be, for example, an average room rate for a room for the specified duration of the guests' stay at the hotel. To confirm these bookings, the “CONFIRM BOOKINGS” tab 710 may be selected. Thereafter, the winning hotel may receive payment or a payment commitment from the OTA 106 for the booking of the plurality of guests. The exact form and timing of the payment, as noted above; may be negotiated between the OTA 106 and/or any involved financial institution.

It is to be understood that the FIGS. 6 and 7 only show an exemplary user interface for such a mobile computing device. Those of skill in this art will recognize that other UI devices may be employed and that an actual implementation, while sharing at least some of the functionality outlined herein, may have a wholly different appearance than that shown in FIGS. 6 and 7.

FIG. 8 is a block diagram of a computer 800 on which embodiments of the present invention may be implemented. Computer system 800 comprises a bus 801 or other communication mechanism for communicating information, and a processor 802 coupled with bus 801 for processing information. Computer system 800 further comprises a random access memory (RAM) or other dynamic storage device 804 (referred to as main memory), coupled to to bus 801 for storing information and instructions to be executed by processor 802. Main memory 804 also may be used for storing temporary variables or other intermediate information during execution of instructions by processor 802. Computer system 800 also includes a read only memory (ROM) and/or other static storage device 806 coupled to bus 801 for storing static information and instructions for processor 802. A data storage device 608, such as a rotating media or a solid state storage device may be coupled to bus 801 for storing information and instructions.

Computer system 800 may also be coupled via bus 801 to a display device 821, for displaying information to a computer user. An alphanumeric input device 822, including alphanumeric and other keys, may be coupled to bus 801 for communicating information and command selections to processor 802. Another type of user input device is cursor control 823, such as a mouse, a trackball, or cursor direction keys for communicating direction information and command selections to processor 802 and for controlling cursor movement on display 821.

The disclosed embodiments are drawn to the use of computer system 800 to provide enable mob bookings of hotel rooms over a computer network, such as the Internet. According to one embodiment, the methods according to the present invention may be implemented by one or more computer systems 800 in response to processor(s) 802 executing sequences of instructions contained in memory 804. Such instructions may be read into memory 804 from another computer-readable medium, such as data storage device 807. Execution of the sequences of instructions contained in memory 804 causes processor(s) 802 to carry out the functionality described above. In alternative embodiments, hard-wired circuitry may be used in place of or in combination with software instructions to implement all or selected portions of the disclosed embodiments. Thus, the embodiments described and shown herein are not limited to any specific combination of hardware circuitry and software.

Accordingly, one embodiment is a computer-readable storage media such as shown at 804 and/or 807 that store sequences of instructions configured to cause a processor, such as shown at 802 to selectively carry out the functionality shown and described relative to FIGS. 1-7. Similarly, one embodiment is a computer comprising a storage device such as shown at 804, 807 and a processor such as shown at 802, with the processor being operative to selectively carry out the functionality shown and described relative to FIGS. 1-7.

While certain embodiments of the inventions have been described, these embodiments have been presented by way of example only, and are not intended to limit the scope of the inventions. Indeed, the novel methods, devices and systems described herein may be embodied in a variety of other forms. Furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions. For example, those skilled in the art will appreciate that in various embodiments, the actual rules of the reverse auction may differ from those shown in the figures and described herein. Depending on the embodiment, certain of the steps described in the example above may be removed, others may be added. Also, the features and attributes of the specific embodiments disclosed above may be combined in different ways to form additional embodiments, all of which fall within the scope of the present disclosure. For example, it will be recognized that the phrase “hotel room” may be extended to any temporary accommodation that are booked for specified periods of time, such those on a cruise ship, for example. Although the present disclosure provides certain preferred embodiments and applications, other embodiments that are apparent to those of ordinary skill in the art, including embodiments which do not provide all of the features and advantages set forth herein, are also within the scope of this disclosure. Accordingly, the scope of the present disclosure is intended to be defined only by reference to the appended claims.

1. A computer-implemented method for an online travel agent to book hotel rooms over a computer network, comprising:
generating at least one collection of hotels and presenting the generated at least one collection of hotels to potential guests over the computer network;
accepting, over the computer network, bookings from at least some of the potential guests to a selected one of the presented at least one collection of hotels;
grouping potential guests having booked a selected collection of hotels and sharing at least one common guest characteristic into a mob;
conducting a reverse auction with participating ones of the plurality of hotels of the selected collection of hotels for bookings of the mob, and
awarding the bookings of the mob to the participating hotel of the selected collection of hotels having won the reverse auction.

2. The computer-implemented method of claim 1, wherein the at least one common guest characteristic comprises at least one of desired location, desired dates of stay, budget, desired star rating.

3. The computer-implemented method of claim 1, wherein the at least one collection of hotels comprises a plurality of hotels sharing at least one common hotel characteristic.

4. The computer-implemented method of claim 3, wherein the at least one common hotel characteristic comprises at least one of location, proximity to a landmark, star rating, amenities, target guest profile and target guest activities.

5. The computer-implemented method of claim 1, wherein generating comprises pre-building the at least one collection of hotels based on curation by travel professionals.

6. The computer-implemented method of claim 1, wherein generating comprises assembling the at least one collection of hotels algorithmically, based at least in part on guest data.

7. The computer-implemented method of claim 6, wherein the guest data comprises at least one of guest search histories and monitored guest preferences.

8. The computer-implemented method of claim 1, wherein generating comprises determining, for each member of the mob, a room rate for each generated hotel collection, the room rate being applicable to each hotel within each respective hotel collection.

9. The computer-implemented method of claim 8, wherein the determined room rate is identical for at least some of the members of the mob.

10. The computer-implemented method of claim 8, wherein the determined room rate is different for at least some of the members of the mob.

11. The computer-implemented method of claim 1, wherein accepting bookings comprises, for each mob member having made a booking, receiving at least one of a commitment to pay and at least a partial payment.

12. The computer-implemented method of claim 1, further comprising incurring, to each mob member having made a commitment to pay or from whom at least a partial payment has been received, an obligation to deliver a room from a hotel of the collection of hotels selected by the mob member.

13. The computer-implemented method of claim 1, wherein the accepting bookings comprises receiving a preference, from a predetermine mob member, of a preferred hotel within the collection of hotels selected by the predetermined mob member.

14. The computer-implemented method of claim 1, wherein conducting comprises starting the reverse auction from a predetermined seed price and ending when a final price is reached, the predetermined seed price being determined by the online travel agent.

15. The computer-implemented method of claim 1, wherein conducting the reverse auction comprises accepting a first bid, and accepting subsequent bids after the first bid, each subsequent bid being lower than, higher than or equal to the accepted first bid.

16. The computer-implemented method of claim 1, further comprising informing the members of the mob from whom bookings were accepted which hotel of the selected collection of hotels won the auction.

17. The computer-implemented method of claim 1, further comprising keeping a final price resulting from the reverse auction secret from at least one of the members of the mob, from non-auction participating hotels of the selected hotel collection and from other hotels not part of the selected hotel collection.

18. The computer-implemented method of claim 1, further comprising logging the guests onto a computer site of the online travel agent from at least one social network site.

19. The computer-implemented method of claim 18, further comprising determining a room rate for each generated collection of hotels to guests based in part on at least one of measured social influence and selected monitored activities or events within the at least one social network computer site.

20. The computer-implemented method of claim 18, further comprising:
designating a mob boss from among the members of the mob, the mob boss being a member of the mob having influenced a greatest number of other guests or potential guests to interact in a predetermined manner with the online travel agent, and
awarding a prize to the mob boss.

21. A computer-implemented method for an online travel agent to make hotel bookings, comprising:
initiating, over a computer network, a reverse auction with a predetermined number of pre-selected hotels for bookings of a predetermined plurality guests from whom an at least partial payment commitment has been received by the online travel agent;
accepting, over the computer network, a first bid from at least one of the predetermined number of pre-selected hotels;
determining which of the predetermined number of pre-selected hotels has won the reverse auction and awarding the bookings to the winning hotel, and
making a financial commitment for the bookings to the winning hotel.

22. The computer-implemented method of claim 21, wherein the first bid comprises an average nightly rate per room that a bidding hotel is willing to accept for the plurality of guests.

23. The computer-implemented method of claim 21, wherein at least some of the plurality of guests have at least partially overlapping check in and check out dates.

24. The computer-implemented method of claim 21, wherein at least some of the plurality of guests have similar hotel requirements.

25. The computer-implemented method of claim 21, further comprising accepting subsequent bids after the first bid, each subsequent bid being lower than, higher than or equal to the accepted first bid and wherein the winning hotel is that hotel from whom a lowest bid has been received.

26. The computer-implemented method of claim 21, wherein the winning hotel is that hotel from whom the online travel agent has received a lowest bid, the method further comprising the online travel agent paying the winning hotel for the bookings based on the received lowest bid.

27. The computer-implemented method of claim 21, wherein the winning hotel is that hotel having submitted a lowest bid, and wherein the method further comprises awarding the bookings to the winning hotel at a winning price corresponding to a received second-lowest bid, minus a pre-determined amount.

28. The computer-implemented method of claim 21, further comprising selectively reducing, by the online travel agent, the received first bid based on a quality score discount representative of at least one of a quality of the bid-submitting hotel and a relationship between the bid-submitting hotel and the online travel agent.

29. The computer-implemented method of claim 28, wherein the method further comprises awarding the bookings to the winning hotel at a winning price corresponding to a received second-lowest bid, minus a pre-determined amount.

30. The computer-implemented method of claim 21, wherein initiating comprises starting the reverse auction from a predetermined seed price set by the online travel agent.

31. A computer-implemented method for a hotel to accept bookings for a plurality of guests, comprising:
receiving from an online travel agent, at a mobile computing device, a request for a bid in an online reverse auction conducted by the online travel agent for pre-paid bookings from the plurality of guests;
accepting the request and submitting, via the mobile computing device, a bid for the bookings for the bookings of the plurality of guests;
receiving a response on the mobile computing device, the response indicating if the submitted bid is a winning bid of the online reverse auction;
booking the plurality of guests if the received response indicates that the submitted bid resulted in the hotel winning the reverse auction, and
receiving payment for booking the plurality of guests from the online travel agent.

32. The computer-implemented method of claim 31, wherein the submitted bid is no greater than a seed price set by the online travel agent.

33. The computer-implemented method of claim 31, wherein the submitted bid comprises an average nightly rate per room that the hotel is willing to accept for the plurality of guests.

34. The computer-implemented method of claim 31, further comprising receiving, on the mobile computing device, an indication of a current lowest bid and receiving request for a subsequent bid.

35. The computer-implemented method of claim 31, wherein receiving payment comprises receiving, from the online travel agent, a price per room based on a last submitted bid.

36. The computer-implemented method of claim 31, wherein the submitted bid is a lowest bid, and wherein receiving payment comprises receiving a payment for booking the plurality of guests at a price per room corresponding to a second-lowest bid, minus a pre-determined amount.
